(19) United States
(12) Patent Application Publication
(10) Pub. No.: US 2023/0303745 A1
(43) Pub. Date: Sep. 28, 2023

(54) COMPOSITION AND METHOD FOR PROVIDING WATER-REPELLENCY

(71) Applicant: HEIQ PTY LTD, Waum Ponds, Victoria (AU)

(72) Inventors: Surya SUBIANTO, Belmont, Victoria (AU); Nathan THOMPSON, Belmont, Victoria (AU); Amol PATIL, Charlemont, Victoria (AU); Abhijeet BAPAT, lndooroopilly, Queensland (AU); Alessandra SUTTI, Torquay, Victoria (AU); Zahra KOMEILY NIA, Mount Duneed, Victoria (AU); Marzieh PARHIZKAR, Waurn Ponds, Victoria (AU); Dominic Andreas RENGGLI, Wandana Heights, Victoria (AU); Murray HEIGHT, Newtown, Victoria (AU)

(21) Appl. No.: 18/043,206

(22) PCT Filed: Aug. 27, 2021
(86) PCT No.: PCT/AU2021/050992

§ 371 Date: Feb. 27, 2023

(30) Foreign Application Priority Data
Aug. 28, 2020 (AU) 2020903096

(51) Int. Cl. C08F 222/06; C08F 8/14; C08F 8/32; C08F 8/46; D06M 15/263

(52) U.S. Cl. CPC C08F 222/06; C08F 8/14; C08F 8/32; C08F 8/46; D06M 15/263; C08F 2810/50; D06M 2200/12

(57) ABSTRACT

The disclosure provides a water-repellent treatment composition including a functionalised copolymer of a monomer including a di-carboxylic acid anhydride group and a monomer selected from vinyl monomers. The vinyl monomer and optionally the monomer include a di-carboxylic acid anhydride group and form a polymer backbone. At least a portion of the di-carboxylic acid anhydride groups are functionalised by a graft pendant group including two or more fatty aliphatic groups linked to the polymer backbone via an ester, amide or imide of the dicarboxylic acid anhydride.

### FIELD

The invention relates to water-repellent compositions and a method of providing water-repellency to substrates, particularly textiles and substrates such as textiles which are treated with the water-repellent compositions.

### BACKGROUND

Substrates that possess water-repellency are desirable in many fabric and textile applications and have been manufactured for some time. Other types of substrates including paper, packaging and cardboard are advantageously rendered water-repellent in many applications. Water-repellency generally means the ability of the substrate to block water from penetrating into the depth of the substrate. In the case of fabric this will inhibit water occupying inter-fiber spaces, as well as from penetrating into the fibers themselves where the fibers have inherent porosity. Hydrophilic stains can be prevented by means of water-repellency. Examples of textiles in which water-repellency is important include clothing such as rain repellent outdoor wear, upholstery applications, carpet and textiles used outdoors including awnings and sunshades.

Water-repellency is conventionally conferred on fabric articles by applying suitable perfluorinated chemicals (PFCs) to the surface of the fabric. Certain categories of perfluorinated compounds (e.g. the C8 perfluorocarbons PFOA and PFOS) are persistent in the environment and in human tissue and there is therefore a need to provide alternative methods for providing water-repellency which minimise or avoid the use of fluorocarbon substances. The C8 fluorocarbon chemistry (the most highly performing product form) is being phased out by regulations due to environmentally persistent residues that are characteristic for C8-based PFCs. The C6 and C4 fluorine-based products are an alternative to C8 products however they are not as effective as C8 and are generally more expensive. Non-fluorine (non-PFC) treatments are growing in importance as they completely avoid any concerns over fluorine-related residues, however their performance currently lags behind fluorine-based treatments. There is a need to raise the performance of non-fluorine treatments to allow reduction in the use of fluorine products or their complete replacement.

Alternative options for obtaining water-repellency often do not provide the required durability and water repellency is lost with time due to laundering or wear. For example, the need to reduce PFC use has resulted in a return to the use of paraffin (wax) treatments but the durability of waxes to repeated washing is relatively poor. Polymer dendrimers have also been used but are relatively expensive to manufacture. Particulate minerals (e.g. silicon dioxide) have also been examined as a way to increase water-repellency as individual substances or in combination with conventional repellency treatments.

There remains a need for alternative methods for providing durable water-repellency, without using a PFC basis.

### SUMMARY

We have now developed a group of polymeric maleic anhydride derivatives which have significantly improved water repellency properties due to grafting with a graft agent which forms a carboxylic ester, amide or imide graft with the carboxylic acid anhydride and provides a plurality of fatty aliphatic groups appended to the backbone at a graft.

According to a first aspect, the invention provides a water-repellent treatment composition comprising a functionalised copolymer of a monomer comprising a di-carboxylic acid anhydride group and a monomer selected from vinyl monomers, wherein the vinyl monomer and optionally the monomer comprising a di-carboxylic acid anhydride group form a polymer backbone, wherein at least a portion of the di-carboxylic acid anhydride groups are functionalised by a graft pendant group comprising two or more fatty aliphatic groups linked to the polymer backbone via an ester, amide or imide of the di-carboxylic acid anhydride.

The functionalised copolymer may comprise one or more than one monomer selected from vinyl monomers and one or more than one monomer comprising a di-carboxylic acid anhydride group. The monomer comprising a di-carboxylic acid anhydride group may be co-polymerised with the vinyl monomer to produce the copolymer, in which case the vinyl monomer and the monomer comprising a di-carboxylic acid anhydride group together form the polymer backbone. Alternatively, the vinyl monomer forms the polymer backbone and the monomer comprising a di-carboxylic acid anhydride group is pendant to the polymer backbone. For example, it may be grafted to the polymer backbone in a post-polymerisation step.

In some embodiments, the graft pendant group is of formula (I):

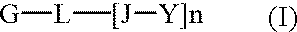

where:
G forms a graft with the copolymer by covalent bonding to one or both carboxylic acid residues (C═O) of the di-carboxylic acid anhydride groups and is selected from the group consisting of O, forming an ester with a carboxylic acid residue, N or NR^{a} wherein R^{a} is hydrogen or C₁₋₂₄ aliphatic, forming an amide with a carboxylic acid residue, and N, forming an imide with the carboxylic acid residues,
Y is fatty aliphatic group or fatty aliphatic acyl group,
L is an organic linker group, with the proviso that when G is N and forms an amide with a carboxylic acid residue, then L is absent,
n is an integer of at least 2 and may be, for example, from 2 to 8, preferably 2 or 3, and
J is independently selected from a bond, O and NR^{b} where R^{b} is hydrogen or C₁₋₂₄ aliphatic.

In some embodiments, the graft pendant group is of formula (II):

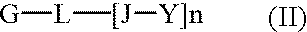

where:
G forms a graft with the copolymer by covalent bonding to one or both carboxylic acid residues (C═O) of the di-carboxylic acid anhydride groups and is selected from the group consisting of O, forming an ester with the carboxylic acid residue, NR^{a} where R^{a} is hydrogen or C₁₋₂₄ aliphatic, forming an amide with the carboxylic acid residue, and N, forming an imide with the carboxylic acid residues,
Y is fatty aliphatic group or fatty aliphatic acyl group,
L is an organic linker group,
n is an integer of at least 2 and may be, for example, 2 to 8 preferably 2 or 3,
J is independently selected from a bond, O and NR^{b} where R^{b} is hydrogen or C₁₋₂₄ aliphatic.

In one embodiment the graft of formula (II) is of formula (IIa):

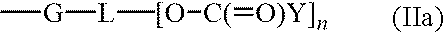

where Y is a fatty aliphatic group and L, G and n are as defined above.

In some embodiments, the graft pendant group is a polyol esterified with at least two C₈₋₂₄ fatty aliphatic acyl groups, wherein the polyol is linked to the polymer backbone via an ester formed between an alcohol residue of the polyol and a carboxylic acid residue of the di-carboxylic acid anhydride.

In some embodiments, the graft pendant group is sorbitan tri-(C₁₂ to C₂₂ fatty aliphatic acyl) linked to the polymer backbone via an ester of the di-carboxylic acid anhydride, for example sorbitan tristearate.

In some embodiments, the monomer comprising a di-carboxylic acid anhydride group is selected from maleic anhydride and tetrahydrophthalic anhydride, and is preferably maleic anhydride.

In some embodiments, the functionalised copolymer is a copolymer of a C₁₂₋₂₂ 1-alkene and maleic anhydride.

In some embodiments, the functionalised copolymer is a functionalised polyolefin-graft-maleic anhydride.

In some embodiments, the water-repellent treatment composition is in the form of a dispersion or emulsion of the functionalised copolymer in a continuous aqueous phase. The dispersion or emulsion may be formed by a process of melt emulsification. In some embodiments, the water-repellent treatment composition is in the form of the dispersion, wherein the particles of functionalised copolymer have a D90 particle size of no more than 5000 nm.

According to a second aspect, the invention provides a process for preparation of the water-repellent treatment compositions of the first aspect, comprising providing a precursor copolymer of a monomer comprising a di-carboxylic acid anhydride group and a monomer selected from vinyl monomers, wherein the vinyl monomer and optionally the monomer comprising a di-carboxylic acid anhydride group form a polymer backbone; and contacting the precursor copolymer with a functionalising agent comprising two or more fatty aliphatic groups and a free alcohol or amino group, preferably a free alcohol group, at a reaction temperature suitable to produce a functionalised copolymer wherein at least a portion of the di-carboxylic acid anhydride groups are functionalised with a graft pendant group comprising the two or more fatty aliphatic groups linked to the backbone via an ester, amide or imide of the di-carboxylic acid anhydride, wherein the reaction temperature is above the melting point of the functionalised copolymer.

In some embodiments, the contacting takes place in a polymer melt phase, thus in the substantial absence of a solvent.

In some embodiments, the process further comprises dispersing the functionalised copolymer, in a molten state, in a continuous aqueous phase to produce an emulsion. The process may further comprise cooling the emulsion to produce the water-repellent treatment composition in the form of a dispersion of solid particles of the functionalised copolymer in the continuous aqueous phase, wherein the solid particles have a D90 particle size of no more than 5000 nm

According to a third aspect, the invention provides a method of durable water-repellent treatment of a substrate comprising applying a water-repellent treatment composition of the first aspect, preferably in the form of an aqueous dispersion, to the substrate, wherein the functionalised copolymer has a melting point of 25° C. to 150° C.; and heating the textile with applied water-repellent treatment composition at a temperature above the melting point of the functionalised copolymer to provide a coating of the functionalised copolymer on the substrate.

In some embodiments, the substrate is a fabric.

In some embodiments, the method comprises cross-linking the functionalised co-polymer on the substrate, for example at a temperature in the range of 120° C. to 180° C.

According to a fourth aspect, the invention provides a water-repellent substrate coated with a functionalised co-polymer of a monomer comprising a di-carboxylic acid anhydride group and a monomer selected from vinyl monomers, wherein the vinyl monomer and optionally the monomer comprising a di-carboxylic acid anhydride group form a polymer backbone, wherein at least a portion of the di-carboxylic acid anhydride groups are functionalised by a graft pendant group comprising two or more fatty aliphatic groups linked to the polymer backbone via an ester, amide or imide of the dicarboxylic acid anhydride.

It will be appreciated that the functionalised co-polymer of the fourth aspect is generally as described herein in relation to the first aspect.

In some embodiments, the substrate is a fabric.

In some embodiments, the functionalised co-polymer is cross-linked.

### DETAILED DESCRIPTION

Where the terms “comprise”, “comprises”, “comprised” or “comprising” are used in this specification (including the claims) they are to be interpreted as specifying the presence of the stated features, integers, steps or components, but not precluding the presence of one or more other features, integers, steps or components, or group thereof.

Esters referred to herein are the functional group R′C(═O)OR″ and described as a product of the reaction of a carboxylic acid or anhydride and an alcohol (the hydrogen of the acid R—COOH is replaced by an alkyl group R″). The acid residue portion of the ester is R′C═O and the alcohol residue portion is -OR″. The terms acid residue and alcohol residue are used herein to describe respective portion of esters.

Similarly, amides referred to herein are the functional group R′C(═O)NRR″ and described as a product of the reaction of a carboxylic acid or anhydride and a single amine (HNRR”). The acid residue portion of the amide is R′C=O and the amine residue portion is -NRR″. The terms acid residue and amine residue are used herein to describe respective portion of amides.

Similarly, imides referred to herein are the functional group R′C(=O)NRC(=O)R″ and described as a product of the reaction of a di-carboxylic acid or anhydride and a primary amine (H₂NR). The acid residue portions of the imide are the R′C=O and R″C=O and the amine residue portion is NR. The terms acid residue and amine residue are used herein to describe respective portion of amides.

The term dispersion refers to the state in which particles of a substance are dispersed in a liquid but are undissolved. The particles in the present invention are typically solid particles at room temperature but may be waxy solids and are dispersed in an aqueous continuous phase.

The term “fatty aliphatic” or “fatty aliphatic group” where used herein refers to aliphatic groups containing 6 to 24 carbon atoms and may optionally include one, two or three (preferably no more than two, more preferably no more than one) hydroxy substituents. Preferred fatty aliphatic groups contain 8 to 22 carbon atoms and more preferably from 12 to 20 carbon atoms, specific examples of fatty aliphatic groups include lauryl, cetyl, stearyl, oleyl, behenyl and ricinoleyl. The fatty aliphatic groups may be straight chain or branched chain, preferably straight chain, and may be saturated or unsaturated and comprise zero, one or two (preferably zero or one) hydroxy (-OH) groups. In some embodiments, the fatty aliphatic groups are aliphatic hydrocarbyl groups (i.e. without heteroatom substituents).

The term “fatty aliphatic acyl” when used herein refers to a group having the form RC=O where R is a fatty aliphatic as defined herein. Specific example of saturated fatty aliphatic acyl include acyl (RC=O) of caprylic acid [CH3(CH2)6COOH], capric acid [CH3(CH2)8COOH], lauric acid [CH3(CH2)10COOH], myristic acid [CH3(CH2)12COOH], palmitic acid [CH3(CH2)14COOH], stearic acid [CH3(CH2)16COOH], arachidic acid {CH3(CH2)18COOH], behenic acid, [CH3(CH2)20COOH] and lignoceric acid, [CH3(CH2)22COOH]. Specific examples of unsaturated fatty aliphatic acyl include acyl derived from myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid and docosahexaenoic acid.

In a further embodiment the fatty aliphatic and fatty aliphatic acyl groups are hydroxy substituted, for example containing one or two hydroxy substituents such as may be present in fatty aliphatic groups of naturally occurring fatty acids. Specific examples of such fatty aliphatic include those present in ricinoleic acid, dihydroxystearic acid, α-hydroxymyristic acid, β-hydroxymyristic acid, α-hydroxypalmitic acid β-hydroxypalmitic acid, β-hydroxystearic acid, 12-hydroxystearic acid, 17-hydroxystearic acid, 3-hydroxy-15-methylhexadecanoic acid and ustilic acid (2,15,16-trihydroxy-hexadecanoic acid).

As used herein, the terms “polymer” and “polymeric material” generally include homopolymers, copolymers and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, a copolymer refers to a polymer comprising two or more monomers, and includes block, graft, random and alternating copolymers, terpolymers, etc. In particular, copolymers described herein include: (i) copolymers where all monomers are co-polymerised and thus incorporated into a polymer backbone, and copolymers where one monomer is grafted to a preformed polymer comprising the other monomer (or monomers), such that the grafted monomer is pendant to a polymer backbone.

The substrate may be of a variety of materials and preferably is fibrous. Examples of substrates include paper, cardboard and fabric. In a preferred set of embodiments, the substrate is a fabric and the fabric substrate may be a woven, knitted or non-woven fabric and may be in the form of a textile for use in any of a range of applications where water-repellency is a useful attribute. The fibers may be of a conventional type having, for example, filament diameters typically more than 10 microns. The melting point of the fabric is not narrowly critical, but it will be understood that it will generally retain integrity under the process conditions used in treatment with the composition. The substrate may not melt or may have a melting point of at least 180° C. The fabric may be of a synthetic, natural fiber or blends of both types and we have found that the process may be used to impart water-repellency to a wide range of fabrics.

Examples of suitable fabric substrates may be selected from the group consisting of cotton, cellulose, acetate, rayon, silk, wool, hemp, polyester, polyurethane (including elastanes such as LYCRA®), polyolefins (including polypropylene), polyamide (including nylon, aramids and para-aramids such as Kevlar®, Twaron®, Nomex, etc.), acrylic, poly(trimethylene terephthalate), glass fibre, carbon fibre, other inorganic fibres (including metal and mineral fibres) and blends of two or more of these materials. The fibers making-up at least a portion of the substrate, can in one set of embodiments be a thermoplastic polymer. Generally, however when the substrate comprises a thermoplastic polymer it has a melting point of over 200° C. Generally, it is not significantly deformed under the conditions of the process. Suitable thermoplastic polymers include polyolefins, polyesters, polyamides, polyurethanes, polyvinylchloride, polytetrafluoroethylene, polystyrene, polyethylene terephthalate, biodegradable polymers such as polylactic acid, and copolymers and blends thereof. Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene, and blends thereof; polybutylene, e.g., poly(1-butene) and poly(2-butene); polypentene, e.g., poly(1-pentene) and poly(2-pentene); poly(3-methyl-1-pentene); poly(4-methyl 1-pentene); and copolymers and blends thereof. Suitable copolymers include random and block copolymers prepared from two or more different unsaturated olefin monomers, such as ethylene/propylene and ethylene/butylene copolymers. Copolymers of caprolactam and alkylene oxide diamine, and the like, as well as blends and copolymers thereof. Suitable polyesters include polyethylene terephthalate, polytrimethylene terephthalate, polybutylene terephthalate, polytetramethylene terephthalate, polycyclohexylene-1,4-dimethylene terephthalate, and isophthalate copolymers thereof, as well as blends thereof.

The water-repellent treatment composition comprises a functionalised copolymer of a monomer comprising a di-carboxylic acid anhydride group and a monomer selected from vinyl monomers, wherein the vinyl monomer and optionally the monomer comprising a di-carboxylic acid anhydride group form a polymer backbone, wherein at least a portion of the di-carboxylic acid anhydride groups are functionalised by a graft pendant group comprising two or more fatty aliphatic groups linked to the polymer backbone via an ester, amide or imide of the di-carboxylic acid anhydride.

The water-repellent treatment composition comprises a graft agent comprising at least two fatty aliphatic groups each comprising 6 to 24 carbon atoms, preferably 8 to 22 carbon atoms such as 8 to 20 or 12 to 22 carbon atoms.

The presence of a high local concentration of the fatty aliphatic groups provided by the multiple fatty aliphatic chains grafted to the backbone via an ester, amide or imide derived from the di-carboxylic acid anhydride groups provides a surprising level of water-repellency and a method of formulating and treating substrates such as textiles which allows manufacturers to take advantage of advantageous properties in applying compositions of the water repellence treatment in the form of stable dispersions.

The graft pendant groups present in the water-repellent treatment composition comprise two or more fatty aliphatic groups.

In one set of embodiments, the graft pendant group is of formula (I):

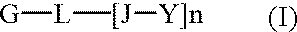

where:
G forms a graft with the copolymer by covalent bonding to one or both carboxylic acid residues (C═O) of the di-carboxylic acid anhydride groups and is selected from the group consisting of O, wherein the O forms an ester with a carboxylic acid residue of the di-carboxylic acid anhydride groups, N or NR^{a} where R^{a} is hydrogen or C₁₋₂₄ aliphatic, wherein the N or NR^{a} forms an amide with a carboxylic acid residue of the di-carboxylic acid anhydride groups, and N, wherein the N forms an imide with the carboxylic acid residues of the di-carboxylic acid anhydride groups,
Y is fatty aliphatic group or fatty aliphatic acyl group,
L is an organic linker group, with the proviso that when G is N and the N forms an amide with a carboxylic acid residue of the di-carboxylic acid anhydride groups, then L is absent,
n is an integer of at least 2 and may be, for example, from 2 to 8, preferably 2 or 3,
J is independently selected from a bond, O and NR^{b} where R^{b} is hydrogen or C₁₋₂₄ aliphatic.

In one set of embodiments the graft pendant group is of formula (II):

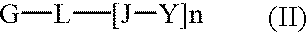

where:
G forms a graft with the copolymer by covalent bonding to one or both carboxylic acid residues (C═O) of the di-carboxylic acid anhydride groups and is selected from the group consisting of O, wherein the O forms an ester with a carboxylic acid residue of the di-carboxylic acid anhydride groups, NR^{a} where R^{a} is hydrogen or C₁₋₂₄ aliphatic, wherein the N or NR^{a} forms an amide with a carboxylic acid residue of the di-carboxylic acid anhydride groups, and N, wherein the N forms an imide with the carboxylic acid residues of the di-carboxylic acid anhydride groups,
Y is fatty aliphatic group or fatty aliphatic acyl group,
L an organic linker group,
n is an integer and is at least 2 and may be, for example, 2 to 8 preferably 2 or 3,
J is independently selected from a bond, O and NR^{b} where R^{b} is hydrogen or C₁₋₂₄ aliphatic.

In a more specific set of embodiments the graft formed with the di-carboxylic acid anhydride provides a pendant group of formula (IIa):

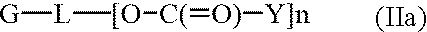

where:
G forms a graft with the copolymer by covalent bonding to one or both carboxylic acid residues (C═O) of the di-carboxylic acid anhydride groups and is selected from the group consisting of O, wherein the O forms an ester with a carboxylic acid residue of the di-carboxylic acid anhydride groups, NR^{a} where R^{a} is hydrogen or C₁₋₂₄ aliphatic, wherein the NR^{a} forms an amide with a carboxylic acid residue of the di-carboxylic acid anhydride groups, and N, wherein the N forms an imide with the carboxylic acid residues of the di-carboxylic acid anhydride groups,
Y is a fatty aliphatic group
L is an organic linker group; and
n is an integer and is at least 2 and may be, for example, 2 to 6, or 2 or 3.

L is generally an organic linking group having a valency of (n+1), and it will be appreciated that L may adopt a wide range of structural configurations capable of bearing two or more fatty aliphatic groups and grafting to the copolymer backbone. In one set of embodiments, L in any of formulae (I), (II) and (IIa) is an organic linker group selected from the group consisting of optionally substituted linear or branched aliphatic hydrocarbon, optionally substituted carbocyclic, optionally substituted heterocyclic, optionally substituted aryl, optionally substituted heteroaryl, and an optionally substituted polymeric segment. In some embodiments, L is a hydrocarbon group optionally substituted with one oxygen atom. In some such embodiments, L comprises no more than 20 carbon atoms, or no more than 10 carbon atoms, or no more than 6 carbon atoms.

The water-repellent functionalised copolymer may be a graft copolymer formed by reaction of a precursor copolymer of a monomer comprising a di-carboxylic acid anhydride group and a monomer selected from vinyl monomers with a graft agent comprising two or more fatty aliphatic groups which conjugates to the copolymer backbone via an ester, amide or imide of the dicarboxylic acid anhydride groups. The graft agent for reaction with the copolymer may be of formula (III):

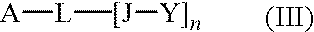

wherein A is OH, NH or NHR^{a} where R^{a} is hydrogen or C₁₋₂₄ aliphatic, L is an organic linker group, with the proviso that when A is NH then L is absent, and J, Y and n are as hereinbefore defined in formula (I) or formula (II), such as (IIIa)

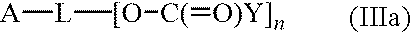

wherein A is OH or NHR^{a} where R^{a} is hydrogen or C₁₋₂₄ aliphatic and L, Y and n are as defined in formula (Ila).

In specific examples, the graft pendant group of formula (I) or formula (II) are selected from the group consisting of:
(A) a polyol esterified with at least two C₈₋₂₄ fatty aliphatic acyl groups and comprising an amine or alcohol conjugated to the polymer backbone via an ester, amide or imide of the di-carboxylic acid anhydride;
(B) the groups of formula (IV):

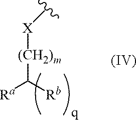

wherein m is 0 to 10 (e.g. 1); q is 1 or 2 (e.g. 1); R^{a} and R^{b} are C₈₋₂₄ fatty aliphatic groups, optionally including one or two hydroxy substituents; X is selected from O or NR^{c} wherein R^{c} is hydrogen or C₁₋₂₄ aliphatic and

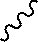

indicates the point of connection to a carboxylic acid residue (C═O) of a di-carboxylic anhydride group of the functionalised copolymer; and
(C) the groups of formula (V):

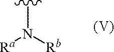

wherein R^{a} and R^{b} are C₈₋₂₄ fatty aliphatic groups and

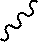

indicates the point of connection to a carboxylic acid residue (C═O) of a di-carboxylic anhydride group of the functionalised copolymer.

In the aspect where the graft pendant group of formula (I) or formula (II) is a group of formula (IV) or (V), specific examples of graft agents include the following compounds, where —OH forms the alcohol residue of the ester or NH forms the amine residue of an amide.

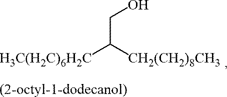

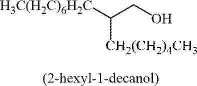

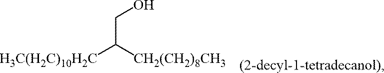

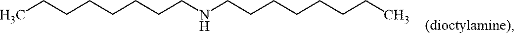

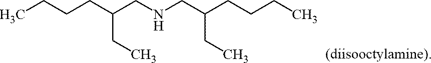

In the aspect where the graft pendant group of formula (I) or formula (II) is a polyol esterified with at least two C₈₋₂₄ aliphatic acyl groups, the polyol may for example be selected from glycerol, erythritol, pentaerythritol, sorbitan, sugars, sugar alcohols and cyclised derivatives of sugar alcohols and is linked to the polymer backbone via an ester formed between an alcohol residue portion of the polyol and a carboxylic acid residue portion of the di-carboxylic acid anhydride. The polyol may comprise three or more alcohol groups with at least two comprising fatty aliphatic acyl esters formed with the alcohols and at least one alcohol forming an ester graft with the di-carboxylic acid anhydride.

In one embodiment the sugars and sugar alcohols are selected from mono and disaccharides. The sugars and sugar alcohols may, for example, be selected from glycerol, erythritol, pentaerythritol, sorbitol, mannitol, xylitol, maltitol, isomalt, erythritol lactitol, sucrose and dextrose. The acid residues of the di-carboxylic acid anhydride groups may be functionalised by a graft pendant group comprising a polyol comprising at least two (e.g. three) —OH groups esterified by a plurality of C₆₋₂₂ fatty aliphatic acyl groups linked to the backbone via an ester formed of an alcohol portion of the polyol and an acid portion of the dicarboxylic acid anhydride. For example, the graft pendant group (the alcohol residue of the linking ester) may be selected from formulae (VIa) to (VIf):

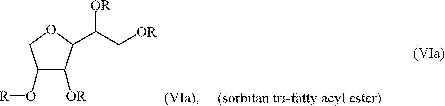

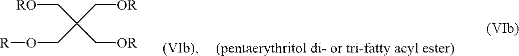

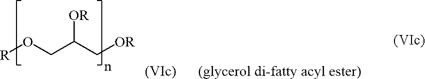

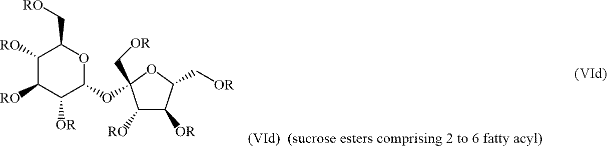

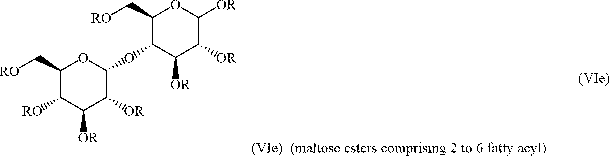

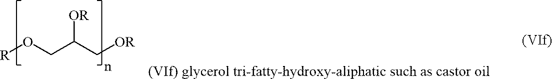

In each of formulae (VIa) to (VIe) at least two R are independently selected from C₁₂₋₂₂ fatty aliphatic acyl groups, one of R forms an ester with an acid of the di-carboxylic acid (as the alcohol residue) and where there are more than three groups OR the additional R groups are independently selected from C₆₋₂₂ fatty aliphatic acyl and hydrogen; and in formula (VIc) n is from 1 to 20, preferably 1 to 10, for example 1.

In Formula (VIf) at least three R are independently selected from C₁₂₋₂₂ fatty aliphatic acyl groups, at least one of the C₁₂₋₂₂ fatty aliphatic acyl groups being substituted by —O— (the residue of an —OH group) which forms an ester with an acid of the di-carboxylic acid (as the alcohol residue), and where there are more than three groups OR the additional R groups are independently selected from C₆₋₂₂ fatty aliphatic acyl and hydrogen; and n is from 1 to 20, preferably 1 to 10, for example 1.

Examples of the polyol ester graft pendant group linked to the polymer backbone via an ester of the di-carboxylic acid anhydride include sorbitan tri(C₁₂₋₂₂ aliphatic acyl), glycerol di(C₁₂₋₂₂ aliphatic acyl), sucrose tri(C₁₂₋₂₂ aliphatic acyl), sucrose penta(C₁₂₋₂₂ aliphatic acyl), sucrose hexa(C₁₂₋₂₂ aliphatic acyl), maltose hexa(C₁₂₋₂₂ aliphatic acyl), polyglyceryl penta (C₁₂₋₂₂ aliphatic acyl), polyglyceryl hepta(C₁₂₋₂₂ aliphatic acyl) and glycerol di- and tri-(fatty aliphatic acyl) wherein at least one of the fatty aliphatic acyl comprises a hydroxy (—OH) substituent.

Specific examples of polyol-derivative graft pendant groups linked to the polymer backbone via an ester of the di-carboxylic acid include sorbitan tristearate, sorbitan trioleate, glycerol distearate, glycerol dioleate, sucrose tristearate, sucrose pentastearate, sucrose hexastearate, maltose hexastearate, polyglyceryl pentastearate and polyglyceryl heptastearate. In some embodiments, the polyol is sorbitan tristearate, the structure of which is shown below.

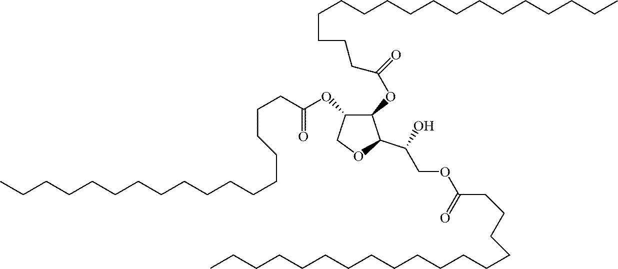 [SMILES: CCCCCCCCCCCCCCCCCC(=O)OC[C@@H](O)[C@H]1OC[C@H](OC(=O)CCCCCCCCCCCCCCCCC)[C@H]1OC(=O)CCCCCCCCCCCCCCCCC]

The fatty aliphatic groups may be C₆ to C₂₄ aliphatic, preferably C₈ to C₂₂ aliphatic and more preferably C₈ to C₂₀ aliphatic such as C₁₂ to C₁₈ aliphatic such as selected from lauryl, cetyl, stearyl and oleyl. The invention allows the use of naturally occurring and bio-derived oils such as di- and tri-glycerides. Di-glycerides may include di-(C₈ to C₂₂ fatty aliphatic acyl)-glycerol which may be 1,2-diacylglycerols, 1,3-diacylglycerols or mixtures thereof. Examples of triglycerides include tri-(C₈ to C₂₂ fatty aliphatic acyl) glycerol in which at least one of the fatty aliphatic acyl groups includes a hydroxy substituent such as in castor oil triglycerides containing tri-ricinoleoyl-glycerol, the structure of which is shown below.

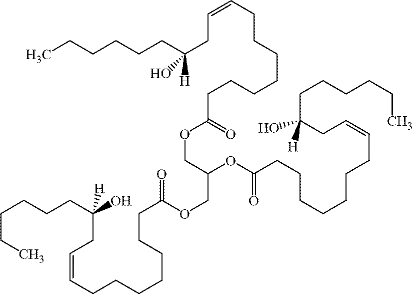 [SMILES: CCCCCC[C@@H](O)C/C=C\CCCCCCCC(=O)OCC(COC(=O)CCCCCCC/C=C\C[C@H](O)CCCCCC)OC(=O)CCCCCCC/C=C\C[C@H](O)CCCCCC]

In a particularly preferred embodiment, the water-repellent treatment functionalised copolymer comprises a plurality of pendant grafted sorbitan tri-(C₁₂ to C₂₂ fatty aliphatic acyl) esters. In such embodiments, the fatty aliphatic acyl groups are preferably unsubstituted by —OH groups.

In one embodiment of the invention the water-repellent agent further comprises a portion of further graft pendant groups linked to the polymer backbone via an ester or amine of the di-carboxylic acid anhydride group, the esters or amines formed between the acid residue portion of the dicarboxylic anhydride and the alcohol or amine residue portion of a compound selected from C₁ to C₁₀ alkanol, C₂ to C₁₀ alkanediol and polyalkylene glycol of molecular weight 200 to 2000, C₁ to C₁₀ amine, C₂ to C₂₀ diamines and C₃ to C₂₀ polyamines. The grafting of C₁ to C₁₀ alkanol and C₁ to C₁₀ amine may be useful to react with residual carboxylic acids not functionalised with the more sterically hindered graft pendant groups. The grafting of polyols and polyamines (preferably added late in the synthesis methodology to avoid premature crosslinking) may be useful to provide free active hydrogen groups (—OH or —NH₂) as crosslinking sites for crosslinking agents such as polyisocyanates or polyesters in the polymer curing step after application to the substrate.

The copolymer to which the water-repellent fatty aliphatic-containing groups are grafted is a copolymer of a monomer comprising a di-carboxylic acid anhydride group and a monomer selected from vinyl monomers, wherein the vinyl monomer and optionally the monomer comprising a di-carboxylic acid anhydride group form the polymer backbone.

The vinyl monomer may be selected from the group of formula (VII):

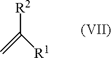

In formula (VII), R¹ is selected from C₁ to C₂₀ alkyl, phenyl, C₁ to C₂₀ alkanoyloxy (i.e. -C(=O)OR), C₁ to C₂₀ carboxylate (i.e. -OC(=O)-R); C₁ to C₂₀ alkoxy (i.e. -OR) and C₂ to C₂₀ (preferably C₂ to C₃) alkenyl; and R² is hydrogen or C₁ to C₄ alkyl.

In some embodiments, the vinyl monomer comprises at least one selected from 1-alkenes (e.g. ethylene, propylene, isobutylene, C₄ to C₂₂ 1-alkenes), dienes (e.g. butadiene, isoprene), styrene, vinyl ether and vinyl acetate.

The copolymer may be a copolymer of the monomer comprising a di-carboxylic acid anhydride group and a single monomer selected from vinyl monomers (e.g. according to formula (VII). However, it is not excluded that the copolymer is a copolymer of the monomer comprising a di-carboxylic acid anhydride group and two or more vinyl monomers (e.g. according to formula (VII).

In some embodiments, the monomer comprising a di-carboxylic acid anhydride group is an unsaturated monomer which is co-polymerised with the vinyl monomer to produce the copolymer. In such cases, both the vinyl monomer and the unsaturated monomer comprising the di-carboxylic acid anhydride form the polymer backbone. Suitable unsaturated monomers comprising a di-carboxylic acid anhydride group include maleic anhydride and tetrahydrophthalic anhydride, preferably maleic anhydride.

In some embodiments, the unsaturated monomer comprising a di-carboxylic anhydride group is maleic anhydride and the vinyl monomer which is copolymerised with the maleic anhydride is of formula (VII), wherein:
R¹ is C₁₀ to C₂₀ alkyl; and
R² is hydrogen.

Examples of suitable precursor copolymers comprising the monomer comprising a di-carboxylic acid anhydride group as part of the polymer backbone (i.e. prior to functionalisation with the graft pendant group) include the following copolymers, where m and n represent the relative molecular proportions of each monomer:

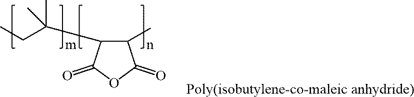

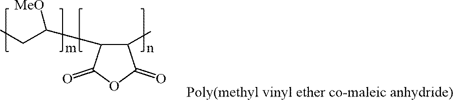

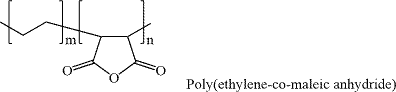

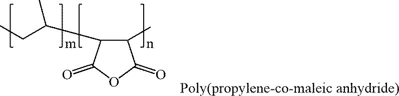

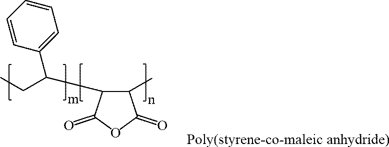

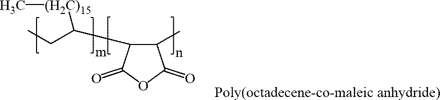

In some embodiments, the monomer comprising di-carboxylic acid anhydride groups is pendant to the polymer backbone. In such embodiments, the vinyl monomer, e.g. one or more monomers according to formula (VII), forms the polymer backbone and the monomer comprising di-carboxylic acid anhydride groups may be grafted to the polymer backbone, for example in a post-polymerisation grafting step.

Suitable polymer backbones to which a monomer comprising di-carboxylic acid anhydride groups may be grafted include polyolefins, for example polymers of ethylene, propylene, isobutylene, butadiene, isoprene and combinations thereof. Suitable monomers comprising di-carboxylic acid anhydride groups to be grafted to the polymer backbone include maleic anhydride and tetrahydrophthalic anhydride, preferably maleic anhydride. The precursor copolymer may thus be a polyolefin-graft-maleic anhydride copolymer.

Examples of suitable precursor copolymers comprising the monomer comprising di-carboxylic acid anhydride groups pendant to the polymer backbone (i.e. prior to functionalisation with the graft pendant group) include the following copolymers, where m and n represent the relative molecular proportions of ungrafted and grafted monomer residue units in the structure:

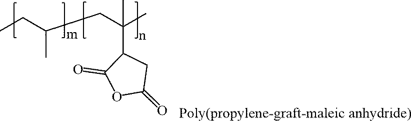

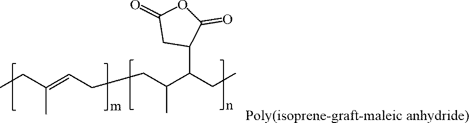

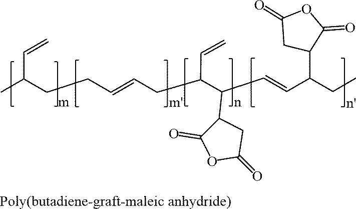

Precursor copolymers (i.e. prior to functionalisation with the graft pendant groups) which have the di-carboxylic acid anhydride functionality pendant to the polymer backbone may have varying molecular weights and may contain variable amounts of the monomer comprising di-carboxylic acid anhydride groups, for example dependant on the molecular weight of the polyolefin precursor and the extent of post-polymerisation grafting of maleic anhydride to this polyolefin precursor. It will be appreciated that preferred copolymer molecular weights and di-carboxylic acid anhydride contents will differ for any given implementation, depending on the selection of monomers and graft pendant groups and considering the required physical and hydrophobic properties of the functionalised copolymer, i.e. after functionalisation with the graft pendant groups.

In some embodiments, the precursor copolymer (prior to functionalisation with the graft pendant groups) is poly(butadiene-graft maleic anhydride), also known as maleinated butadiene. In some embodiments, the poly(butadiene-graft maleic anhydride) has an average molecular weight (Mn) of between 1,000 and 10,000 g/mol, such as between 2,000 and 5,000 g/mol. In some embodiments, the poly(butadiene-graft maleic anhydride) is a liquid having a viscosity between 1,000 and 100,000 cP at 25° C., such as between 2,000 and 30,000 cP at 25° C. In some embodiments, the poly(butadiene-graft maleic anhydride) comprised between 1 and 20 grafted maleic anhydride groups per chain, such as between 2 and 8 MA groups per chain. In some embodiments, the poly(butadiene-graft maleic anhydride) has a vinyl content of less than 50%, such as less than 30%.

Considering now the functionalised copolymer (after functionalisation with the graft pendant groups), in the embodiment where the monomer comprising a di-carboxylic acid anhydride group is part of the polymer backbone the backbone may comprise a multiplicity of backbone units of formula (VIII):

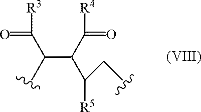

In formula (VIII), at least one of R³ and R⁴ comprises a pendant graft group comprising two or more fatty aliphatic groups, such as described above in formula (I), (II) and (lia); R⁵ is selected from C₁ to C₂₀ alkyl, phenyl, C₁ to C₂₀ alkanoyloxy (i.e. -C(=O)OR), C₁ to C₂₀ carboxylate (i.e. -OC(=O)-R); C₁ to C₂₀ alkoxy (i.e. -OR) and mixtures thereof, and

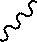

indicates the points of connection to the remainder of the polymer backbone.

The vinyl monomer in a preferred embodiment is octadecene (i.e. R⁵ is C₁₆ alkyl).

In the embodiment where the monomer comprising a di-carboxylic acid anhydride group is pendant to the polymer backbone, the copolymer may comprise a multiplicity of backbone units of formula (IX):

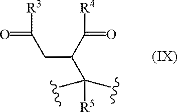

In formula (IX), at least one of R³ and R⁴ comprises a pendant graft group comprising two or more fatty aliphatic groups, such as described above in formula (I), (II) and (IIa); R⁵ is selected from hydrogen and C₁₋₄ alkyl or alkenyl, and

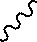

indicates the points of connection to the remainder of the polymer backbone.

In a preferred embodiment, the polymer backbone is a homopolymer of propylene, isobutylene, butadiene or isoprene.

For example, in preferred embodiments of both formulae (VIII) and (IX), at least one of R³ and R⁴ is of formula (X):

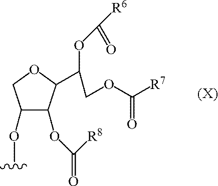

wherein of R⁶, R⁷, R⁸ are C₁₂-C₂₂ alkyl such as stearyl and

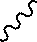

indicates the point of connection to the acid residue of the di-carboxylic acid anhydride.

In both formulae (VIII) and (IX), the other of R³ and R⁴ (if only one is a graft pendant group comprising two or more fatty aliphatic groups) may be —OH, thus forming part of a free carboxylic acid group remaining after reaction of the maleic anhydride with a single graft pendant alcohol. Alternatively, the other of R³ and R⁴ may be -OR⁹, where -OR⁹ is the alcohol residue portion of a compound selected from C₁ to C₁₀ alkanol, C₂ to C₁₀ alkanediol and polyalkylene glycol of molecular weight 200 to 2000. Such compounds may be added as modifiers during the synthesis of the functionalised copolymer. One non-limiting example of a functionalised copolymer is produced from poly(butadiene graft-maleic anhydride) as the precursor polymer, sorbitan tristearate (available commercially as Span 65) as the graft agent and 1 -octanol as modifier. A representative structure of this copolymer is shown below:

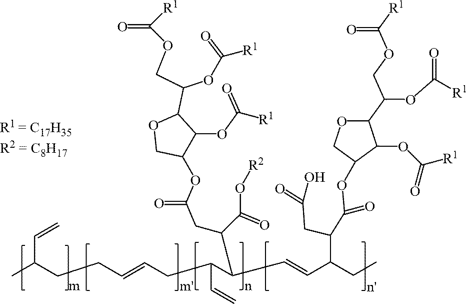

The functionalised copolymer of the water-repellent treatment composition generally has physical and hydrophobic properties which facilitate its application to substrates and provide water repellency thereto. In some embodiments, therefore, the functionalised copolymer has one or more of, and preferably each of, the following properties:
a melting point in the range of from 25 to 150° C., such as from 30 to 70° C., for example from 30 to 50° C.;
a crystallisation temperature in the range of from 25 to 90° C., such as from 30 to 70° C., for example from 30 to 60° C.;
a melt viscosity in the range of from 1 to 10,000 cP at 90° C., such as from 100 to 10000 cP at 90° C., for example from 300 to 7000 cP at 90° C.; and
a water contact angle, measured on a planar film of the functionalised copolymer, in the range of from 91 to 180°, such as from 100 to 150°, for example greater than or equal to 110°.

As used throughout this disclosure, the melting point may be measured by differential scanning calorimetry, for example with a TA Q200 Differential Scanning Calorimeter. Melt viscosity may be measured with a rheometer (e.g. a TA HR-3 rheometer) using a Peltier plate and a cone-plate geometry via a dynamic viscosity measurement, in flow sweep mode. Water contact angle may be measured using a standard water droplet method.

It will be appreciated that the melting point, crystallisation temperature, melt viscosity and water contact angle will depend on the structure of the functionalised copolymer, including variables such as the molecular weight, the nature of the vinyl monomer, the amount of monomer comprising the di-carboxylic acid anhydride group, the type of graft pendant groups comprising two or more fatty aliphatic groups and degree of functionalisation by these groups, and the addition of any modifiers to react with residual free carboxylic acid groups. However, with the benefit of the present disclosure, a wide range of functionalised copolymers having the required functional properties can be produced with no more than routine experimentation.

While the functionalised copolymer may advantageously be a solid at room temperature, it should be appreciated that this is not essential. The functionalised co-polymer is typically cross-linked during or after application to a substrate, so that a functionalised copolymer which is liquid at room temperature liquid can form a solid cross-linked water-repellent polymeric coating on the substrate.

The water-repellent treatment composition may be in the form of a dispersion or emulsion of the functionalised copolymer in a continuous aqueous phase. At room temperature, the water-repellent treatment composition may be in the form of a dispersion of solid particles of the functionalised copolymer, particularly when the melting point of the functionalised copolymer is in the preferred ranges disclosed herein. The particles of functionalised copolymer may have a D90 particle size of no more than 5000 nm, for example no more than 2000 nm, or less than 1000 nm, or less than 500 nm.

The water-repellent treatment composition may be produced as a concentrated dispersion or emulsion of the functionalised copolymer in the continuous aqueous phase, for example comprising the functionalised copolymer in an amount of between 1 and 30 wt.%, or between 10 and 30 wt.%, such as between 15 and 30 wt.%, each relative to the total weight of the concentrated composition. The concentrated composition may comprise a surfactant, for example a cationic or non-ionic surfactant, in an amount of less than 30 wt.%, or between 0.1 and 10 wt.%, such as between 0.1 and 5 wt.%, each relative to the total weight of the concentrated composition. The surfactant is typically present to facilitate melt emulsification of the water repellent composition and/or to stabilise the resultant dispersion. The pH of the concentrated composition may be between 1 and 8, such as between 3 and 7, for example between 3 and 5.5.

Such concentrated water-repellent treatment compositions will generally be diluted immediately prior to use to form a diluted water-repellent treatment composition formulated for application to the substrate and thus having a suitable concentration of functionalised co-polymer for this purpose. The extent of dilution is based on the desired amount of functionalised polymer to be applied to the substrate, which may be in the range of between 0.1 and 15% wt.%, such as between 0.2% and 13 wt.%, for example between 0.4% and 12% wt.%, each based on the weight of the treated substrate.

The diluted water-repellent treatment composition may further comprise one or more additives including cross-linkers, for example blocked isocyanate crosslinkers, for example in an amount of in the range of between 0.1 and 3 wt.%, or between 0.5 and 3 wt.%, such as between 1 and 2.5 wt.%, each relative to the total weight of the diluted composition. Suitable crosslinkers may include polyisocyanates, diacids, di-acid chlorides, di-anhydrides, diols such as polyether diols, polyester diols and mixtures thereof which are capable of reacting with free acid, O—H or N—H groups on the functionalised co-polymer. However, because the treatment composition may be in the form of a stabilised dispersion of solid particles, the polymer is not cross-linked until melted during the subsequent application step. Other conventional additives in water-repellency treatment compositions may also be added, including binders, extenders, wetting agents and pH modifiers.

The water-repellent treatment composition may be prepared by a method comprising: providing a precursor copolymer of a monomer comprising a di-carboxylic acid anhydride group and a monomer selected from vinyl monomers, wherein the vinyl monomer and optionally the monomer comprising a di-carboxylic acid anhydride group form a polymer backbone, and contacting the precursor copolymer with a functionalising agent comprising two or more fatty aliphatic groups and a free alcohol or amino group, preferably a free alcohol group, at a reaction temperature suitable to produce a functionalised copolymer wherein at least a portion of the di-carboxylic acid anhydride groups are functionalised with a graft pendant group comprising the two or more fatty aliphatic groups linked to the backbone via an ester, amide or imide of the di-carboxylic acid anhydride. Generally, the reaction temperature is above the melting point of the functionalised copolymer. In some embodiments, the reaction takes place in a polymer melt phase, i.e. not in a solution phase.

In some embodiments, the precursor copolymer is a copolymer of maleic anhydride and vinyl monomer. As disclosed herein, suitable precursor copolymers may comprise the maleic anhydride and vinyl monomer co-polymerised together such that both monomers form the polymer backbone. Alternatively, suitable precursor copolymers may comprise a graft copolymer formed by grafting maleic anhydride to a vinyl polymer such that the maleic anhydride functionality in the copolymer is pendant to the polymer backbone.

The method may further include a step of dispersing the functionalised copolymer in a continuous aqueous phase, preferably under high shear conditions. The step of dispersing the functionalised copolymer in the continuous phase is preferably conducted with the functionalised copolymer in a molten state. In one embodiment the aqueous phase is at a temperature above the melting point of the functionalised copolymer to provide emulsification of the melt. In another embodiment the molten functionalised copolymer is introduced to the high shear zone of a high shear mixer such as a rotor-stator high shear mixer at a temperature above or below the melting point of the functionalised copolymer to form a dispersion of fine particles of the copolymer.

Melt modifiers may be added to the functionalised copolymer to facilitate melt synthesis an/or melt emulsification. Suitable melt modifiers include vegetable oil tri-glycerides and sorbitan tristearate.

The water-repellent composition is preferably in the form of an aqueous dispersion of the water-repellent material which may be prepared by emulsification of the functionalised copolymer. In the emulsification process a non-aqueous phase comprising the functionalised copolymer as a solution or melt is emulsified in water to form dispersed particles which typically have a D90 of no more than 2 micron and preferably no more than 1 micron such as no more than 500 nanometers. The dispersion may be stabilised with one or more suitable surfactants. The dispersion is typically stabilised by cooling the emulsion below the melting point of the water-repellent functionalised copolymer.

The surfactant may be anionic, cationic, amphoteric or non-ionic. Examples of suitable surfactants include alkyl phenol alkoxylates, alkyl aryl sulfonates, ethoxylated fatty aliphatic amines, fatty aliphatic alcohols such as where the fatty aliphatic group is a C₈ to C₂₀ aliphatic alcohols ethoxylated with from 2 to 10 ethylene oxide (EO) units. An example of such a surfactant is a cocoamine ethoxylated with 2 EO units and example of which is sold under the tradename CAM2. Further examples of suitable surfactants include sorbitan monooleate (SPAN 80) and sorbitan monolaurate (SPAN 20).

The fine dispersion which may be achieved using the functionalised copolymer of the invention provides significant advantages in treating substrates and particularly fabrics. The melt reaction and melt emulsification process allows stable dispersions of the water repellent treatment composition to be obtained directly in water thereby minimising or completely avoiding the need for volatile organic solvents. The fine dispersion also allows a homogeneously distributed coating of water repellent which on heating to above the melting temperature of the water repellent functionalised copolymer, optionally to a temperature of 120° C. to 180° C. such as 130° C. to 160° C. (which may facilitate curing of the polymer and drying of moisture content from the substrate), and subsequently cooling, is transformed to a coherent, durable, and highly effective water repellent coating.

In embodiments where the functionalised copolymer comprises free alcohol, amine or acid groups a cross-linking agent may be included in the final diluted formulation. Suitable cross-linking agents may include polyisocyanates, diacids, di-acid chlorides, di-anhydrides and diols. In this embodiment the heating to above the melting temperature of the water-repellent functionalised copolymer, preferably to a temperature of 120° C. to 180° C. such as 130° C. to 160° C. may provide curing of the composition on the substrate as a result of cross-linking of the copolymer.

The invention further provides a method of durable water-repellent treatment of a substrate comprising applying the water-repellent treatment composition as disclosed herein to the substrate, wherein the functionalised copolymer has a melting point of 25° C. to 150° C.; and heating the textile with applied water-repellent treatment composition at a temperature above the melting point of the functionalised copolymer to provide the substrate coated with the functionalised copolymer.

The applied water-repellent treatment composition, which will typically be a dilute water-repellent treatment composition comprising a dispersion or emulsion of the functionalised copolymer in a continuous aqueous phase as described above, may be applied to the fabric by conventional methods including padding, spraying, exhaust, foam, print, or knife application. In some embodiments, it is applied by padding.

Following the application, the functionalised copolymer may be cured at elevated temperature or under UV radiation, thereby cross-linking the functionalised copolymer. The curing may be performed at elevated temperatures of between 25 and 180° C., such as between 100 and 160° C., for example between 120 and 160° C.

The method is particularly advantageous where the substrate is a fabric and provides water repellency which allows the use of conventional water-repellent agents such as fluorinated agents to be reduced or avoided. The invention also has the significant advantage of providing long-term water-repellent properties which have previously been difficult or impossible to achieve without fluorinated water-repellent agents.

Key advantages of the method and water-repellent agent include:
Non-urethane synthesis path (i.e. non-isocyanate reaction basis)
Ability to avoid organic solvents and separations (melt reaction path)
well defined and reproducible polymer backbone for hydrophobic group grafting.

The following examples illustrate the invention in further detail, but the examples should not be construed as limiting the scope of the invention as described herein.

### EXAMPLES

The Examples describe three phases of experimental activity, namely:
Synthesis: Synthesis of the water-repellent co-polymer materials
Formulation: Formulation of the water-repellent co-polymer materials into liquid mixtures that can be applied to surfaces.
Surface treatment: application of the liquid formulations onto surfaces (e.g. textiles)

### Example 1 - Synthesis Methods

The following synthesis methods refer to the following functional components in describing the synthesis steps and properties of the materials:

Backbone polymer: polymer structure featuring moieties capable of reacting with side chain components and modifiers/additives.

Side chain components: Compounds that are selected to impart the target functionality to the polymer backbone (e.g. water-repellency) when reacted (grafted) to the backbone polymer moieties.

Modifiers and additives: Compounds added to react and modify the properties of the polymer and/or to provide a physical modification to the reactant mixture (e.g. rheology adjustment).

Three categories of synthesis methods were used:

Melt-phase synthesis: combination of synthesis components in a heated, molten mass.

Solution-based synthesis: solvent-borne grafting of functional groups onto the polymer backbone.

### Example 2 - Melt-Phase Synthesis

The melt phase synthesis of the polymer product can take place through a variety of approaches (Methods 2A-2D) described as follows.

### Method 2A - Backbone: High Maleic Anhydride Content Polymers. No Modifiers or Other Additives Used

The backbone polymer component and side-chain components are combined (mass depends on the backbone polymer and side chain components used (refer to examples table for typical amounts) in a sealed metal pot (typical vol. 500 mL) with 50x 5 mm diameter stainless steel ball bearings inside for mechanical agitation. Pots are placed in a temperature-controlled oven with a mechanism for controlled rotation of the pots (Ahiba datacolor). The mixture in the pots is agitated continuously at 90° C.-130° C. for 6-18 hours. Directly following the synthesis time, the product is poured in a molten state into silicone moulds and cooled to a solid, waxy block.

### Method 2B - Backbone: High Maleic Anhydride Content Polymers. Melt Modifiers Used

In a stirred reaction vessel (with inlets that allow addition of reagents) the melt modifier is heated up to the desired temperature (110° C.-150° C.) after which the specified quantity of backbone polymer (refer to the examples table for typical amounts) is gradually added. The mixture is mechanically agitated until a homogeneous melt is obtained. The side chain component is added and the mixture is brought to the desired reaction temperature (80° C.-130° C.). The mixture is continuously stirred for 2-24 hours at the desired reaction temperature. Directly following the synthesis time, the product is poured in a molten state into silicone moulds and cooled to a solid, waxy block.

### Method 2C - Backbone: High Maleic Anhydride Content Polymers. Melt Modifiers and Additives Used

In a stirred reaction vessel (with inlets that allow addition of reagents) the melt modifier is heated up to the desired temperature (110° C.-150° C.) after which the specified quantity of backbone polymer (refer to the examples table for typical amounts) is gradually added. The mixture is mechanically agitated until a homogeneous melt is obtained. The side chain component is added, and the mixture is brought to the desired reaction temperature (80° C.-130° C.) and continuously stirred for 12-24 hours. The additive is added, and the mixture is stirred at temperature for a further 2-4 hours. Directly following the synthesis time, the product is poured in a molten state into silicone moulds and cooled to a solid, waxy block.

### Method 2D - Backbone: Grafted Maleic Anhydride, Low Maleic Anhydride Content Polymers. No Melt Modifiers or Other Additives Used

The backbone polymer is added into a polymer mixer (screw batch mixer or extruder) and maintained at 150° C.-190° C. until completely molten. The side chain component is gradually added until the desired concentration is reached (refer to the examples table for typical amounts). The mixture is processed in the polymer mixer for 30-90 minutes until a homogeneous consistency is achieved. The melt mixture is extruded and cooled to obtain a solid polymer form. Melt modifier may be added for the purpose of aiding emulsification in downstream formulation processing, in which case the polymer is remelted and fed into an extruder/mixer with the appropriate melt modifier added and the polymer mixture is subsequently re-extruded and cooled to obtain a polymer form.

### Example 3 - Solution-Based Synthesis

Modification of maleic anhydride copolymer

One or more side chain modifiers are used. High maleic anhydride content polymers are used as main-chain backbone polymers. The backbone polymer is added portion wise to a preheated high-boiling-temperature solvent (e.g. dimethylformamide, dihydrolevoglucosenone, propylene carbonate, diphenyl ether) at 80° C.-130° C. under continued stirring in a reaction flask equipped with a water, oil or air-cooled condenser, and a mechanical stirrer. Once the polymer is completely dissolved, the side chain component(s) are added portion wise (ideally using an addition funnel) under continued stirring over 0.5 to 2 hours up to a desired concentration. After complete addition, the mixture is stirred 80° C.-130° C. for 2 h. The temperature is raised to reflux temperature of the solvent (e.g. 153° C. for dimethylformamide) and maintained for 4-16 h. After synthesis, the polymer is isolated either by distilling off the solvent, or via precipitation into a non-solvent (e.g. acetone), followed by filtration and drying in a vacuum oven. This stage may result in a melt-dispersible or water-dispersible product.

When the polymer isolated using the solution-based approach described above contains pendant amine groups, it may be further modified as follows. The polymer is re-dissolved into a suitable solvent (e.g. tetrahydrofuran) in a reaction flask fitted with a condenser. An alkyl halide (e.g. iodoethane) (two equivalents per equivalent of amine groups) is added and the mixture stirred at 55° C. for 4 to 16 hours. The solvents are removed under reduced pressure, and the polymer is re-dissolved in aqueous brine (saturated sodium chloride solution) using heat if required. The aqueous solution is stirred for 2 hours, and the polymer is isolated via extraction into a hydrophobic solvent (e.g. chloroform). Alternately, the polymer can also be isolated by dialysis in aqueous solutions of reducing concentrations of sodium chloride, followed by freeze drying.

Pendant tertiary amine groups grafted onto the polymer can also facilitate direct dispersion of the polymer in an acidic aqueous solution. The polymer is added portion wise to an aqueous solution at pH ≈ 3 (using HCI, or acetic acid), under vigorous stirring. Stirring is continued at 20° C.-50° C. until complete dissolution (1 to 4 hours). The resulting aqueous solution may be directly used to formulate an aqueous liquid surface treatment mixture.

### Example 4 - Dispersion Composition

The various polymer products synthesized with the above methods may be subsequently processed into aqueous formulations suitable for application onto various surfaces to impart the desired properties of the polymer component to the surface.

### Aqueous Phase Preparation

Surfactant (0.01% to 10% w/w), and if required a co-surfactant (0.01 to 10% w/w), are added to deionised water and gently stirred until dispersed. The pH is adjusted to the desired range as required. Anti-foaming agents (0-5% w/w) may optionally be added and gently stirred until dispersed.

### Addition of Water-Dispersible Products

The following procedure is used for water-dispersible polymer products, in particular functionalised copolymers which are liquid at room temperature. The aqueous phase as prepared above is added in a known weight to a beaker (e.g. 500 ml to 2 L) and maintained under mechanical agitation at the desired temperature (10° C.-80° C. preferably 25° C. to 75° C.). The synthesized water-dispersible polymer product is then added to the beaker in a quantity that will result in a 3-30% w/w ratio of the product in the resulting aqueous phase. The mixture is maintained under agitation at the desired temperature (10° C.-80° C., particularly 25° C. to 75° C.) for a desired period of time (10 to 60 min) and then allowed to cool to room temperature.

### Injection of Melt-Dispersible Products

The following procedure is used for melt-dispersible polymer products, in particular functionalised copolymers which are solids at room temperature and thus need to be melted to allow dispersion in water. The aqueous phase as prepared above is added in a known weight to a beaker (e.g. 500 ml-2 L), and heated and maintained at a temperature in the range 75-90° C. The polymer product resulting from melt-phase synthesis is added into a pressurized heated chamber (wax injector), in a quantity that will result in a w/w% of 3-30% (based on known weight of aqueous phase). The wax injector is then set to heat to 90° C. The injector outlet (a ⅛″ tube), shaped to allow injection from the bottom of the beaker to enable molten polymer to issue in an upwards direction into the beaker volume. Upon both wax injector and aqueous phase reaching the desired temperature range, a high-shear mixer or agitator is lowered into the beaker such that the high shear mechanism is aligned axially with the vertical injector tube outlet with a separation distance of 3 to 5 cm. The high shear mixer is activated at a setting low enough to not cause excessive foaming of the aqueous phase. The wax injector outlet is then opened, and polymer melt allowed to flow into the aqueous phase until the molten material in the wax injector reservoir is exhausted.

### Homogenisation

A high-pressure homogeniser is pre-heated to 75° C.-90° C. using an external heat source. The aqueous mixtures produced by either above approach (for water-dispersible or melt-dispersible polymers) is pre-heated to the desired temperature range (e.g. 75° C.-90° C.) and transferred into the feed reservoir of a homogeniser unit. The aqueous mixture is passed through the homogeniser at a pressure in the range of 200 to 1000 bar. The homogenised mixture can be returned to the feed reservoir for subsequent re-homogenisation (recirculation mode) or the product can be collected after a single passage through the homogeniser and passed repeatedly through the homogeniser in a batch-wise manner up to a preferred number of times. The number of passes and the pressure are determined by the desired particle size distribution to be achieved. On the final pass through the homogeniser, the product mixture is directed into a cooled vessel configured to ensure the temperature of the quenched product mixture does not exceed 25° C.

### Example 5 - Method of Surface Treatment

Different processing techniques may be used to apply the aqueous formulations containing the polymer materials onto different surfaces (e.g. textiles).

### Application Onto Textiles: Padding (Laboratory Scale)

Desired amounts of the aqueous formulations and of optional textile treatment additives (e.g. acetic acid, surfactants, or cross-linkers such as polyisocyanates) are combined in a beaker (volume 100-2000 mL) at room temperature and are diluted to the desired concentration using softened or deionised water to yield the padding bath formulations. The desired concentration for the components of the padding bath formulation is calculated as per standard practice based on the wet-uptake of the fabric to be treated under the conditions used for the padding, and on the basis of the level of functionality sought. The components of the aqueous bath formulation are combined in % w/w ratios previously observed to yield an optically stable bath, the desired functionality level and shelf-life. The resulting padding bath formulation is stirred for 10-30 min and issued to a laboratory textile padder (e.g. Mathis). The padder rolls are set to the desired speed and pressure (e.g. 1-20 m/min and 2-4 bar). The fabric sample is then processed through the padder rolls and impregnated with the bath formulation liquor. The fabric is then transferred into a laboratory dryer oven (e.g. Mathis Labdryer LTE) to dry and optionally cure the treated fabric. The drying step involves exposing the padded fabric to temperatures in the range of 80° C.-120° C. for 1-6 min and the optional curing step is determined on the basis of the preferred curing temperature for other components of the formulation, typically 130° C.-200° C. for 2-6 min. The fabric is then removed from the dryer and set aside in a temperature and humidity conditioned room (for instance 20° C.-23° C. and 65%-75% RH) for a time between 24 and 72 hours prior to testing and characterization.

### Example 6 - Exemplary Functionalised Copolymers

The water-repellency co-polymers shown in Table 1 can be prepared by the described methods.

TABLE 1

| | | | | |
|---|---|---|---|---|
| Backbone component | Side chain component | Melt modifier | Other additives | Polymer code / Method / reaction conditions |
| Poly(octadecene-co-maleic anhydride) (POMA) softening point 120-130° C., melt index ~21 g/10 min (230° C./5.0 kg). CAS Number: 25266-02-8 | Dioctylamine m.p. 13-14° C., b.p. 298° C. CAS Number 1120-48-5 | Sorbitan tristearate | n/a | Polymer 6-1. Method 2B POMA (10 g) added to molten sorbitan tristearate (15 g) at 120° C. to dissolve under mechanical mixing, after which 7 g of dioctylamine is added and the reaction is continued at 120° C. for 3 h. (The amine will graft preferentially over the sorbitan tristearate due to its higher reactivity) |
| | Diisooctylamine b.p. 123° C. CAS Number: 106-20-7 | Sorbitan tristearate | n/a | Polymer 6-2. Method 2B POMA (10 g) added to molten sorbitan tristearate (15 g) at 120° C. to dissolve under mechanical mixing, after which 7 g of amine is added and the reaction is continued at 120° C. for 3 h (The amine will graft preferentially over the sorbitan tristearate due to its higher reactivity) |
| | 2-octyl-1-dodecanol m.p. 1° C. b.p. 234° C. CAS Number: 5333-42-6 | Vegetable oil tri-glycerides | Poly(caprolactone) diol (PCL diol) | Polymer 6-3. Method 2C POMA (10 g), 2-octyl-1-dodecanol (5 g), and 20 g of vegetable oil tri-glycerides are mixed and melted at 110° C., and the mixture is stirred at 130° C. for 8 h. 0.1 g of PCL diol is added 2 h prior to completion for improved film formation. |
| | Sorbitan Tristearate m.p. 56° C. CAS Number: 26658-19-5 | n/a | 1-octanol | Polymer 6-4. Method 2C POMA (10 g) and sorbitan tristearate (30 g) are mixed and melted at 130° C., after which the mixture is stirred at 130° C. for 8 h. 1-octanol is added c.a. 1 h prior to end of reaction to provide greater hydrophobicity |
| | Sorbitan Tristearate m.p. 56° C. CAS Number: 26658-19-5 | n/a | Hydrophobic SC3 recombinant protein | Polymer 6-5. Method 2C POMA (10 g) and sorbitan tristearate (30 g) are mixed and melted at 130° C., after which the mixture is stirred at 130° C. for 8 h. After cooling, a DMF solution is added containing 1 mg/mL of the additive and the reaction is continued at 80° C. for 6 h. |
| | Sorbitan Tristearate m.p. 56° C. CAS Number: 26658-19-5 | Glycerol polyethylene glycol hydroxy-stearate | Celyl alcohol m.p. 49C | Polymer 6-6. Method 2C POMA (10 g), sorbitan tristearate (5 g), and 1 g of cetyl alcohol are mixed and melted at 120° C., after which the mixture is stirred at 120° C. for 8 h. Glycerol polyethylene glycol hydroxy-stearate is added at the end of the synthesis to facilitate melt emulsification. |
| | Castor oil (triester of glycerol and ricinoleic acid), m.p. < 20° C. CAS Number: 8001-79-4 (and derivatives thereof, e.g. hydrogenated castor oil) | Vegetable oil | n/a | Polymer 6-7. Method 2B POMA (10 g) is added to vegetable oil (3 g) and castor oil (30 g) at 120° C. to dissolve under mechanical mixing, after which the reaction is continued at 120° C. for 6 h. |
| Poly(methyl vinyl ether-co-maleic anhydride) (PMVMA) softening point 140-155° C., Decomposition temp 300° C. CAS Number: 9011-16-9 | Sorbitan trioleate m.p. -23° C. CAS Number: 26266-58-0 | Vegetable oil tri-glycerides | 1-dodecanol | Polymer 6-8. Method 2C PMVMA (10 g) is mechanically mixed with molten vegetable oil triglycerides (10 g) at 150° C. and sorbitan trioleate (40 g) is slowly added under mechanical agitation/mixing at temperature. Once a lower viscosity melt is obtained the mixture is stirred at 130° C. for 4 h, after which 5 g of 1-dodecanol is added |
| Poly(isobutylene-co-maleic anhydride) (PIMA) softening point 141° C. CAS Number: 26426-80-2 | Sorbitan trioleate m.p. -23° C. CAS Number: 26266-58-0 | Vegetable oil tri-glycerides | n/a | Polymer 6-9. Method 2B PIMA (10 g) is mechanically mixed with molten vegetable oil triglycerides(10 g) at 150° C. and sorbitan trioleate (60 g) is slowly added under mechanical agitation/mixing at temperature. Once a low viscosity melt is obtained the mixture is stirred at 130° C. for 4 h |
| | Sorbitan Tristearate m.p. 56° C. CAS Number: 26658-19-5 | n/a | 1-pentanol (N,N-dimethylethylenediamine) | Polymer 6-10. Method 2C PIMA (10 g) added to molten sorbitan tristearate (10 g) at 140° C. under mechanical mixing for 2 h, after which 5 g of N,N-dimethyl-ethylene-diamine and 5 g of 1-pentanol is added and the reaction is continued at 120° C. for 2 h |
| | Sorbitan Tristearate m.p. 56° C. CAS Number: 26658-19-5 | n/a | Amodimethicone CAS Number: 71750-80-6 | Polymer 6-11. Method 2C PIMA (10 g) added to molten sorbitan tristearate (10 g) at 140° C. under mechanical mixing for 2 h, after which 1 g of amodimethicone is added and the reaction is continued at 120° C. for 2 h |
| Poly(styrene-co-maleic anhydride) (PSMA); softening point 125° C., m.p ca 170° C. CAS Number: 9011-13-6 | Sorbitan trioleate m.p. -23° C. CAS Number: 26266-58-0 | Vegetable oil tri-glycerides | n/a | Polymer 6-12. Method 2B PSMA (10 g) is mechanically mixed with molten vegetable oil tri-glycerides(10 g) at 150° C. and sorbitan trioleate (60 g) is slowly added under mechanical agitation/mixing at temperature. Once a low viscosity melt is obtained the mixture is stirred at 130° C. for 4 h |
| Poly(isoprene-graft-maleic anhydride); Viscous liquid. CAS Number: 139948-75-7 | Dioctylamine m.p. 13-14° C., b.p.298° C. CAS Number 1120-48-5 | n/a | n/a | Polymer 6-13. Method 2A Poly(isoprene-graft-maleic anhydride)(100 g) containing about 3 wt.% MA is heated to 90° C. under mechanical mixing, after which 15 g of dioctylamine is added and the reaction is continued at 90° C. for 2 h. |
| | Diisooctylamine b.p. 123° C. CAS Number: 106-20-7 | n/a | n/a | Polymer 6-14. Method 2A Poly(isoprene-graft-maleic anhydride)(100 g) containing about 3 wt.% MA is heated to 90° C. under mechanical mixing, after which 15 g of diisooctylamine is added and the reaction is continued at 90° C. for 2 h. |
| | 2-decyl-1-tetradecanol m.p. 17-20° C. b.p. 271-275° C. CAS Number: 58670-89-6 | n/a | n/a | Polymer 6-15. Method 2A Poly(isoprene-graft-maleic anhydride)(100 g) containing about 3 wt.% MA is heated to 90° C. under mechanical mixing, after which 15 g of 2-decyl-1-tetradecanol is added and the reaction is continued at 90° C. for 2 h. |
| | Sorbitan Tristearate m.p. 56° C. CAS Number: 26658-19-5 | n/a | n/a | Polymer 6-16. Method 2A Poly(isoprene-graft-maleic anhydride)(100 g) containing about 1-3 wt.% MA is mixed with sorbitan tristearate (50 g) and is heated to 130° C. under mechanical mixing and the reaction is continued at 130° C. for 1 h. |
| Poly(propylene-graft-maleic anhydride) (PP-g-MA) softening point 147° C., m.p. 150-160° C. melt index ~115 g/10 min (190° C., 2.16 KG). CAS Number: 25722-45-6 | Sorbitan Tristearate m.p. 56° C. CAS Number: 26658-19-5 | n/a | n/a | Polymer 6-17. Method 2D PP-g-MA (10 g) (c.a. 1-2.5 wt.% MA) is put into a screw mixer/extruder at 160° C. until molten, after which 1 g of sorbitan tristearate is added and mixed together at 150° C. for 2 h. |
| Poly(butadiene-graft-maleic anhydride); Viscous liquid. CAS Number: 25655-35-0 | Dioctylamine m.p. 13-14° C., b.p.298° C. CAS Number 1120-48-5 | n/a | n/a | Polymer 6-18. Method 2A Poly(butadiene-graft-maleic anhydride) (100 g) (5-13 wt.% MA) is heated to 90° C. under mechanical mixing, after which 15 g of dioctylamine is added and the reaction is continued at 90° C. for 2 h. |
| | Diisooctylamine b.p. 123° C. CAS Number: 106-20-7 | n/a | n/a | Polymer 6-19. Method 2A Poly(butadiene-graft-maleic anhydride) (100 g) (5-13 wt.% MA) is heated to 90° C. under mechanical mixing, after which 15 g of diisooctylamine is added and the reaction is continued at 90° C. for 2 h. |
| | 2-decyl-1-tetradecanol m.p. 17-20° C. b.p. 271-275° C. CAS Number: 58670-89-6 | n/a | n/a | Polymer 6-20. Method 2A Poly(butadiene-graft-maleic anhydride) (100 g) (5-13 wt.% MA) is heated to 90° C. under mechanical mixing, after which 15 g of 2-decyl-1-tetradecanol is added and the reaction is continued at 90° C. for 2 h. |
| | Sorbitan Tristearate m.p. 56° C. CAS Number: 26658-19-5 | n/a | n/a | Polymer 6-21. Method 2A Poly(butadiene-graft-maleic anhydride) (100 g) (5-13 wt.% MA) is mixed with sorbitan tristearate (115 g) and is heated to 130° C. under mechanical mixing and the reaction is continued at 130° C. for 1 h. |

### Example 7 - Preparation of Co-Polymer With Sorbitan Tristearate Grafted To Poly(Octadecene-Co-Maleic Anhydride)

### Step 1: Reaction

Sorbitan tristearate commercially available under the trademark SPAN 65 was heated to 130° C. in a reaction vessel to provide a melt and poly(octadecene-co-maleic anhydride (POMA) was added to the melt in the reaction vessel in a mass ratio of 1 : 2.8 of POMA to SPAN65. The mixture was stirred at 120° C. for 8 - 12 hours.

### Step 2: Additives/Modifiers (Optional)

Reaction additives such as polycaprolactonediol (PCL) or polyisocyanate and 1-octanol may be added to the melt to provide further graft functional groups and the mixture stirred for a further 1-4 hours.

Non-reacting additives (e.g. plasticizers and surfactants) can be added to melt following the reaction.

### Step 3: Completion

The melt was poured while still hot (>85° C.) into beaker/tray and allowed to solidify.

### Step 4: Formation of Aqueous Dispersion

The solid wax blocks are put into the wax injector and heated to between 70-90° C. The molten wax is injected into a heated water/surfactant mixture under shear using the wax injector at 80° C. to form a microfine oil-in-water type emulsion of the molten water-repellent agent which is subject to homogenisation and rapidly cooled to form a suspension of the particles of water-repellent agent in water.

### Step 5: Treatment of Textiles

The formulation obtained in step 4 is diluted to 1-12% w/w using deionised or tap water. Additives such as crosslinkers are added in appropriate concentrations and the mixture is used in a padding bath or in an exhaust bath.

Textile samples were treated with the diluted formulation by operating the padder at a suitable pressure. In the example provided: padder nip pressure is 4 bar and roller speed is 2 m/min.

The fabrics were subjected to heat treatment to dry the coating and activate eventually present crosslinkers. The examples provided used a drying step of 3 min at 110° C. and 3 min at 160° C.

The water-repellent characteristics of the suspension were assessed by a method which is a modification of AATCC test method 22-2010 (Water-repellency: Spray test):

In the tests the method involved exposing fabric samples to larger volumes of water (closer to Bundesmann test exposure levels) and included a moisture mass uptake measurement.

The steps used in assessment of water-repellency are as follows:
1. Pre-weighed fabric specimen (20 cm × 20 cm) is fastened on the hoop and placed on the AATCC spray tester
2. Allow water to impinge on fabric surface in the form of shower (per AATCC 22)
3. At completion tap the hoop twice to remove loosely held water drops from the fabric surface (per AATCC 22)
4. Compare wet pattern of the fabric specimen with standard photographs and assign a spray rating (per AATCC 22)
5. Measure final weight of the fabric. Calculate % water uptake (difference between final weight and dry weight, divided by dry weight).
6. Testing was conducted before and after exposing the samples to repeated laundry cycles (20x cycles at 40° C. according to ISO 6330).

### Example 8 - Preparation of Co-Polymer With Sorbitan Tristearate Grafted to Poly(Butadiene-Graft-Maleic Anhydride)

### Step 1: Reaction

Sorbitan tristearate commercially available under the trademark SPAN 65 was heated to 130° C. in a reaction vessel to provide a melt and poly(butadiene-graft-maleic anhydride) (15 wt.% maleic anhydride) was added to the melt in the reaction vessel in a mass ratio of 1 : 1.5 of poly(butadiene-graft-maleic anhydride) to SPAN65. The mixture was stirred at 130° C. for 3-24 hours.

### Step 2: Additives/Modifiers (Optional)

Reaction additives such as polycaprolactonediol (PCL) or polyisocyanate and 1-octanol may be added to the melt to provide further graft functional groups and the mixture stirred for a further 1-4 hours.

Non-reacting additives (e.g. plasticizers and surfactants) can be added to melt following the reaction.

### Step 3: Completion

The melt was poured while still hot (>85° C.) into beaker/tray and allowed to solidify.

### Step 4: Formation of Aqueous Dispersion

The solid wax blocks are heated to between 50-90° C. to melt the polymer. Optionally, water can be introduced into the molten mass as steam or liquid to facilitate processing. The molten mass is added to a heated water/surfactant/modifier mixture under shear to form a microfine oil-in-water type emulsion of the molten water-repellent agent which is optionally subject to homogenisation and rapidly cooled to form a suspension of the particles of water-repellent agent in water.

### Step 5: Treatment of Textiles

The formulation obtained in step 4 is diluted to 1-12% w/w using deionised or tap water. Additives such as crosslinkers and pH modifiers are added in appropriate concentrations and the mixture is used in a padding bath or in an exhaust bath.

Textile samples were treated with the diluted formulation by operating the padder at a suitable pressure. In the example provided: padder nip pressure is 4 bar and roller speed is 2 m/min.

The fabrics were subjected to heat treatment to dry the coating and activate eventually present crosslinkers. The examples provided used a drying step of 3 min at 110° C. and 3 min at 160° C.

The water-repellent characteristics of the suspension were assessed by a method which is a modification of AATCC test method 22-2010 (Water-repellency: Spray test), as described in Example 7.

### Example 9 - Graft Copolymer Fabric Treatment With Isocyanate Cross-Linker

Co-polymers for water-repellency compositions in accordance with the invention were synthesised using an infrared-lamp heated batch reactor system (Ahiba Datacolor) to provide heating and agitation. Sorbitan tristearate, commercially available under the trademark SPAN 65, was mixed in a reaction vessel with poly(octadecene-co-maleic anhydride (POMA) in a mass ratio of 1 : 2.8 of POMA to SPAN65. A temperature ramp of 2° C. per minute was applied to go from room temperature to 100° C. (40 minutes). A second temperature ramp of 0.5° C. per minute was applied to heat the vessel from 100° C. to 130° C. (60 minutes). After 8 h dwell time at 130° C., the mixture was cooled at 1° C. per min till approx. 90° C.

Upon cooling the mixture was solidified in a form suitable for use in a wax injector. 90 g of the resulting mixture was injected into 300 mL of a pH 4 acetic acid solution in deionised water containing 1% w/w commercially available mildly cationic surfactant (CAM 2). The mixture was heated at 80° C. under stirring by means of overhead mixers at 10,000 rpm. The mixture was homogenised in a benchtop homogeniser with a pressure of 500 bar. Ice was added to quench the mixture and yield a formulation with solids concentration of 14%w/w.

The mixture was diluted to 12% w/w using DI water. Invention Example 9a did not contain further adjuvants. Invention Example 9b was formulated identically to Example 9a, with the addition of a hydrophobic silicone softener emulsion, at a concentration such that it would be deposited on the fabric at 1%w/w-of-fabric.

A laboratory padder with an applied nip pressure of 4 bar and a roller speed of 2 m/min was used to treat a woven nylon textile. A blocked isocyanate crosslinker was added to the mixtures of Examples 9a and 9b to achieve crosslinker deposition on the fabric at 2%w-of-crosslinker/w-of-fabric. The fabrics were subjected to heat treatment in a laboratory stenter oven to dry the coating (3 min at 110° C.) followed by curing (3 min at 160° C.) to activate the crosslinkers.

The water repellent properties of the prototype fabrics were assessed as described in Example 7.

The results of the testing are shown in Table 2

TABLE 2

| | Initial | | After 20 wash cycles (40° C.) | |
|---|---|---|---|---|
| | Water uptake (%) | Spray rating (/100) | Water uptake (%) | Spray rating (/100) |
| Composition Example 9a | 4.1 | 90 | 4.3 | 75 |
| Composition Example 9b | 1.7 | 90 | 4.5 | 85 |

The testing data in Table 2 shows that the textile treatments of Example 9a and 9b achieve a good water repellent spray rating and low water uptake. The water repellency performance of the treatments is durable to laundry cycles.

### Example 9 - Comparison of Polymers Grafted With Pendant Groups Having Multiple Fatty Aliphatic Groups Vs a Single Fatty Aliphatic Group

The co-polymers shown in Table 3 were prepared using polymer precursors sourced from Sigma Aldrich. The poly(butadiene-graft-maleic anhydride) used contained 13 wt.% maleic anhydride. The physical properties of the polymers were compared after cooling to room temperature, and the water contact angle was determined on a film of the polymer applied to a glass slide.

TABLE 3

| Polymer number (Table 1) | Backbone component | Side chain component | Reacted polymer properties (room temp) | Contact angle (°) |
|---|---|---|---|---|
| Comparative | Poly(octadecene-co-maleic anhydride) (POMA) | 1-octanol | Hard, glassy solid | 95 |
| 6-4 | Poly(octadecene-co-maleic anhydride) (POMA) | sorbitan tristearate | Soft waxy solid | 113 |
| Comparative | Poly(isoprene-graft-maleic anhydride) | sorbitan monolaureate | Very soft, tacky solid (very viscous and doesn’t flow) | c.a. 10 |
| 6-16 | Poly(isoprene-graft-maleic anhydride) | sorbitan tristearate | Soft waxy solid | 108 |
| 6-21 | Poly(butadiene-graft-maleic anhydride) | sorbitan tristearate | Soft waxy solid | 112 |
| 6-15 | Poly(isoprene-graft-maleic anhydride) | 2-decyl-1-tetradecanol | liquid | |
| 6-20 | Poly(butadiene-graft-maleic anhydride) | 2-decyl-1-tetradecanol | liquid | |

The results indicate that the tristearate side chain (graft pendant group with three fatty aliphatic groups) provides a high water contact angle (hydrophobic) and favourable polymer physical properties compared to mono-side chain components.

Polymers 6-15 and 6-20 (Table 2) with 2-decyl-1-tetradecanol derived graft pendant groups were liquid at room temperature. These polymers will nevertheless be suitable as water-repellent functionalised copolymers if cross-linked during or after application to a substrate.

Finally, it is understood that various other modifications and/or alterations may be made without departing from the spirit of the present invention as outlined herein.

1. A water-repellent treatment composition comprising a functionalised copolymer of a monomer comprising a di-carboxylic acid anhydride group and a monomer selected from vinyl monomers, wherein the vinyl monomer and optionally the monomer comprising a di-carboxylic acid anhydride group form a polymer backbone,
wherein at least a portion of the di-carboxylic acid anhydride groups are functionalised by a graft pendant group comprising two or more fatty aliphatic groups linked to the polymer backbone via an ester, amide or imide of the dicarboxylic acid anhydride.

2. The water-repellent treatment composition according to claim 1, wherein the two or more fatty aliphatic groups are C₈ to C₂₀ aliphatic groups.

3-4. (canceled)

5. The water-repellent treatment composition according to claim 1, wherein the graft pendant group is of formula (II): 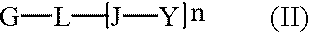
where:
G forms a graft with the copolymer by covalent bonding to one or both carboxylic acid residues (C═O) of the di-carboxylic acid anhydride groups and is selected from the group consisting of O, forming an ester with a carboxylic acid residue, NR^{a} where R^{a} is hydrogen or C₁₋ ₂₄ aliphatic, forming an amide with a carboxylic acid residue, and N, forming an imide with the carboxylic acid residues,
Y is fatty aliphatic group or fatty aliphatic acyl group,
L is an organic linker group,
n is an integer of at least 2, and
J is independently selected from a bond, O and NR^{b} where R^{b} is hydrogen or C₁₋₂₄ aliphatic.

6. The water-repellent treatment composition according to claim 5, wherein the graft pendant group of formula (II) has formula (IIa): 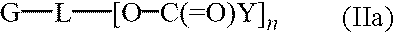
where Y is a fatty aliphatic group.

7. (canceled)

8. The water-repellent treatment composition according to claim 1, wherein the graft pendant group is selected from the group consisting of:
(A) a polyol esterified with at least two C₈₋₂₄ fatty aliphatic acyl groups and comprising an amine or alcohol conjugated to the polymer backbone via an ester, amide or imide of the di-carboxylic acid anhydride;
(B) the groups of formula (IV): 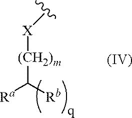
wherein m is 0 to 10; q is 1 or 2; R
^{a} and R^{b} are C₈₋₂₄ fatty aliphatic groups, optionally including one or two hydroxy substituents; X is selected from O or NR^{c} wherein R^{c} is hydrogen or C₁₋₂₄ aliphatic and 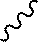
indicates the point of connection to a carboxylic acid residue (C═O) of a di-carboxylic anhydride group of the functionalised copolymer; and
(C) the groups of formula (V): 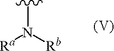
wherein R
^{a} and R^{b} are C₈₋₂₄ fatty aliphatic groups and 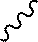
indicates the point of connection to a carboxylic acid residue (C═O) of a di-carboxylic anhydride group of the functionalised copolymer.

9. The water-repellent treatment composition according to claim 1, wherein the graft pendant group is a polyol esterified with at least two C₈₋₂₄ fatty aliphatic acyl groups, wherein the polyol is linked to the polymer backbone via an ester formed between an alcohol residue of the polyol and a carboxylic acid residue of the di-carboxylic acid anhydride.

10. The water-repellent treatment composition according to claim 9 wherein the polyol is selected from glycerol, erythritol, pentaerythritol, sorbitan, sugars, sugar alcohols and cyclised derivatives of sugar alcohols.

11-15. (canceled)

16. The water-repellent treatment composition according to claim 1, wherein the graft pendant group is sorbitan tri-(C₁₂ to C₂₂ fatty aliphatic acyl) linked to the polymer backbone via an ester of the di-carboxylic acid anhydride.

17-20. (canceled)

21. The water-repellent treatment composition according to claim 1, wherein the vinyl monomer forms the polymer backbone and the monomer comprising a di-carboxylic acid anhydride group is pendant to the polymer backbone.

22. The water-repellent treatment composition according to claim 21, wherein the functionalised copolymer is a functionalised polyolefin-graft-maleic anhydride copolymer.

23. The water-repellent treatment composition according to claim 1, wherein a further portion of the di-carboxylic acid anhydride groups are esterified by a compound selected from C₁ to C₁₀ alkanol, C₂ to C₁₀ alkanediol and polyalkylene glycol of molecular weight 200 to 2000.

24. The water-repellent treatment composition according to claim 1, wherein the functionalised copolymer comprises a multiplicity of backbone units of formula (VIII): 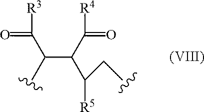
wherein at least one of R³ and R⁴ comprises a graft pendant group comprising two or more fatty aliphatic groups, optionally according to formula (I); R⁵ is selected from C₁ to C₂₀ alkyl, phenyl, C₁ to C₂₀ alkanoyloxy, C₁ to C₂₀ carboxylate; C₁ to C₂₀ alkoxy and mixtures thereof, and 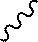
indicates the points of connection to the remainder of the polymer backbone,
wherein one of R³ and R⁴ is an alcohol residue of sorbitan tri-(C₁₂ to C₂₂ fatty aliphatic acyl) and the other of R³ and R⁴ is an alcohol residue of a compound selected from C₁ to C₁₀ alkoxy, C₂ to C₁₀-alkanediol and polyalkylene glycol of molecular weight 200 to 2000, or hydroxy.

25. The water-repellent treatment composition according to claim 1, wherein the functionalised copolymer comprises a multiplicity of backbone units of formula (IX): 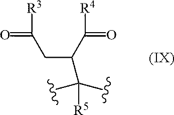
wherein at least one of R³ and R⁴ comprises a pendant graft group comprising two or more fatty aliphatic groups, optionally according to formula (I); R⁵ is selected from hydrogen and C₁₋₄ alkyl or alkenyl, and 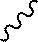
indicates the points of connection to the remainder of the polymer backbone,
wherein one of R³ and R⁴ is an alcohol residue of sorbitan tri-(C₁₂ to C₂₂ fatty aliphatic acyl) and the other of R³ and R⁴ is an alcohol residue of a compound selected from C₁ to C₁₀ alkoxy, C₂ to C₁₀-alkanediol and polyalkylene glycol of molecular weight 200 to 2000, or hydroxy.

26-27. (canceled)

28. The water-repellent treatment composition according to claim 1, wherein the functionalised copolymer has a melting point in the range of from 25° C. to 150° C.

29. The water-repellent treatment composition according to claim 1 in the form of a dispersion or emulsion of the functionalised copolymer in a continuous aqueous phase.

30. (canceled)

31. The water-repellent treatment composition according to claim 1, further comprising a cross-linking agent selected from polyisocyanates, diacids, di-acid chlorides, di-anhydrides, diols and mixtures thereof.

32. A process for preparation of the water-repellent treatment composition of claim 1, comprising:
providing a precursor copolymer of a monomer comprising a di-carboxylic acid anhydride group and a monomer selected from vinyl monomers, wherein the vinyl monomer and optionally the monomer comprising a di-carboxylic acid anhydride group form a polymer backbone; and
contacting the precursor copolymer with a functionalising agent comprising two or more fatty aliphatic groups and a free alcohol or amino group at a reaction temperature suitable to produce a functionalised copolymer wherein at least a portion of the di-carboxylic acid anhydride groups are functionalised with a graft pendant group comprising the two or more fatty aliphatic groups linked to the backbone via an ester, amide or imide of the di-carboxylic acid anhydride,
wherein the reaction temperature is above the melting point of the functionalised copolymer.

33-36. (canceled)

37. The process according to claim 32, further comprising dispersing the functionalised copolymer, in a molten state, in a continuous aqueous phase to produce an emulsion, and cooling the emulsion to produce the water-repellent treatment composition in the form of a dispersion of solid particles of the functionalised copolymer in the continuous aqueous phase, wherein the solid particles have a D90 particle size of no more than 5000 nm.

38. (canceled)

39. A method of durable water-repellent treatment of a substrate comprising:
applying the water-repellent treatment composition of claim 1 to the substrate, wherein the functionalised copolymer has a melting point of 25° C. to 150° C.; and
heating the textile with applied water-repellent treatment composition at a temperature above the melting point of the functionalised copolymer to provide the substrate coated with the functionalised copolymer.

40-41. (canceled)

42. A water-repellent substrate coated with a functionalised co-polymer of a monomer comprising a di-carboxylic acid anhydride group and a monomer selected from vinyl monomers, wherein the vinyl monomer and optionally the monomer comprising a di-carboxylic acid anhydride group form a polymer backbone,
wherein at least a portion of the di-carboxylic acid anhydride groups are functionalised by a graft pendant group comprising two or more fatty aliphatic groups linked to the polymer backbone via an ester, amide or imide of the dicarboxylic acid anhydride.

43-44. (canceled)
